(19) United States
(12) Patent Application Publication
(10) Pub. No.: US 2006/0130620 A1
(43) Pub. Date: Jun. 22, 2006

(54) Spanner

(75) Inventors: Hae Yang Park, Ulsan (KR); Ho Gun Park, Ulsan (KR)

Correspondence Address: SUGHRUE MION, PLLC, 2100 PENNSYLVANIA AVENUE, N.W., SUITE 800, WASHINGTON, DC, 20037, US

(73) Assignee: WORLD VISION

(21) Appl. No.: 11/211,612

(22) Filed: Aug. 26, 2005

(30) Foreign Application Priority Data
Dec. 20, 2004 (KR) 10-2004-0109022
May 19, 2005 (KR) 10-2005-0042129

(51) Int. Cl. B25B 13/12

(52) U.S. Cl. 81/179

(57) ABSTRACT

There is provided a spanner comprising: a head portion fastening and loosening an object: a pair of slide pieces symmetrically positioned inside the head portion in a wedge shape, each slide piece being coupled to the head portion to be externally slidable between the head portion and the object; and a coil spring disposed between an inner bottom surface of the head portion and one end of each slide piece opposed to the inner bottom surface, the coil spring elastically supporting each slide piece so as to elastically bias the slide piece in a direction opposite to an opening direction of the head portion. Because the spanner having the above-mentioned construction is provided with the slidable slide piece, it is possible to continuously fasten and loosen a bolt without pulling out the spanner even in a small space.

### TECHNICAL FIELD

The present invention relates to a work tool and more particularly to a spanner for fastening or loosening a bolt or a nut.

### BACKGROUND ART

Generally, spanners are tools for fastening or loosening fitting elements such as bolts and nuts and have various sizes and shapes.

Conventionally, the spanners for fastening or loosening the bolts and the nuts generally have a structure shown in FIGS. 1 and 2.

Referring to FIG. 1, a spanner 1 includes a head 2 into which the head of a bolt 4 is inserted and a handle 3 extending from the head 2. The spanner 1 can fasten and loosen the bolt 4 by revolving the bolt 4 by a predetermined angle.

However, the conventional spanner 1 has inconvenience that the head of the bolt 4 should be inserted into the head 2 of the spanner 1 and then revolved by a predetermined angle with the handle 3 so as to perform works and that the bolt 4 should be inserted again into the head 2 of the spanner 1 and then revolved again after the works are completed.

In addition, as shown in FIG. 2, since a space of about 120° for revolving the handle 3 is required to insert the head 2 of the spanner 1 into the bolt 4, the spanner 1 has inconvenience that it is difficult to perform works in a small space.

### DETAILED DESCRIPTION OF THE INVENTION

### TECHNICAL GOAL OF THE INVENTION

The present invention is contrived to solve the above-mentioned problems and it is an object of the present invention to provide a spanner with an improved structure which can continuously perform a smooth fastening or loosening operation without pulling out a head of the spanner even in a small space.

### DISCLOSURE OF THE INVENTION

According to an aspect of the present invention, there is provided a spanner comprising: a head portion fastening and loosening an object: a pair of slide pieces having a wedge shape and symmetrically positioned inside the head portion, each slide piece being coupled to the head portion to be externally slidable between the head portion and the object; and a coil spring disposed between an inner bottom surface of the head portion and one end of each slide piece opposed to the inner bottom surface, the coil spring elastically supporting each slide piece so as to elastically bias the slide piece in a direction opposite to an opening direction of the head portion.

According to another aspect of the invention, there is provided a spanner comprising: a head portion fastening and loosening an object: a slide piece having a wedge shape, the slide piece being coupled to the head portion to be externally slidable between the head portion and the object; and a coil spring disposed between an inner bottom surface of the head portion and one end of the slide piece opposed to the inner bottom surface, the coil spring elastically supporting the slide piece so as to elastically bias the slide piece in a direction opposite to an opening direction of the head portion.

Fixing members fixed to the inner bottom of the head portion and one end of the corresponding slide piece may be coupled to both ends of each coil spring.

Protrusions for giving a frictional force may be formed on one surface of each slide piece coming in contact with the object.

An arc-shaped groove may be formed in the inner bottom surface of the head portion.

### EFFECT OF THE INVENTION

As described above, the spanner according to the present invention has the following effects.

First, since a bolt or a nut can be continuously fastened or loosened by rewinding the head portion of the spanner without pulling it out, it is possible to rapidly and efficiently perform the fastening or loosening operation.

Second, since the fastening or loosening operation can be performed even in a narrow space of about 30°, the spanner gives excellent workability. In addition, since the slide pieces connected to the coil springs can elastically slide, it is also possible to smoothly fasten or loosen a heavily eroded bolt, a hexagonal bolt, an octagonal bolt, and a circular bolt.

### BRIEF DESCRIPTION OF THE DRAWINGS

FIGS. 1 and 2 are perspective views illustrating a conventional spanner;

FIG. 3 is a perspective view illustrating a spanner according to an embodiment of the present invention;

FIGS. 4 to 6 are perspective views illustrating operating states of the spanner shown in FIG. 2;

FIG. 7 is an enlarged perspective view illustrating a state where the spanner shown in FIG. 3 is applied to a circular bolt;

FIG. 8 is a perspective view illustrating a case where the spanner shown in FIG. 3 has no protrusion;

FIG. 9 is a perspective view illustrating a spanner according to another embodiment of the present invention;

FIGS. 10 to 12 are perspective views illustrating operating states of the spanner shown in FIG. 9;

FIG. 13 is an enlarged perspective view illustrating a state where the spanner shown in FIG. 8 is applied to a circular bolt; and

FIG. 14 is a perspective view illustrating a case where the spanner shown in FIG. 8 has no protrusion.

### BEST MODE FOR CARRYING OUT THE INVENTION

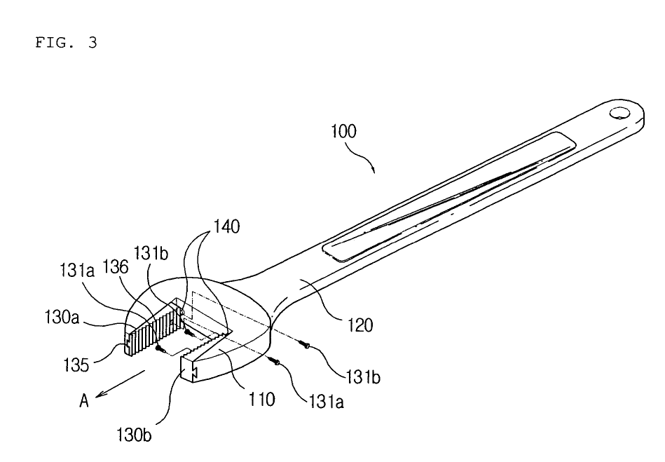

FIG. 3 is a perspective view illustrating a spanner according to an embodiment of the present invention.

Referring to FIG. 3, the spanner 100 according to an embodiment of the present invention includes a handle 120 and a head 110 which is formed at an end of the handle 120 so as to fasten and loosen an object. The head 110 is opened in an A direction in an approximately U shape so as to bite a bolt as an object. Therefore, a user can fasten or loosen a bolt 4 by revolving the bolt by a predetermined angle in one direction or the opposite direction with the handle 120 extending from the head 110 of the spanner 100.

A first slide piece 130a and a second piece 130b are provided inside the head 110 to slide through a slide groove 135 between the head 110 and the bolt 4. At this time, the respective wedge-shaped slide pieces 130a and 130b are symmetrically disposed about the bolt.

Further, protrusions 136 are formed one surface of each of the first and second slide pieces 130a and 130b to effectively fasten or loosen an object by increasing a frictional force.

A coil spring 140 is provided at one end of each slide pieces 130a and 130b so as to elastically bias the slide pieces 130a and 130b in the A direction, which is the opening direction of the head 110, and to enhance a contact force with the bolt 40. The coil springs 140 may be replaced with a leaf spring.

In addition, a fixing member 131b fixed to the head 110 can be disposed at one end of each coil spring 140 and a fixing member 131a fixed to the corresponding slide pieces 130a and 130b can be disposed at the other end thereof.

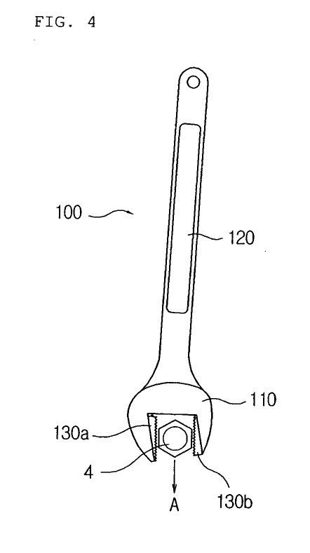

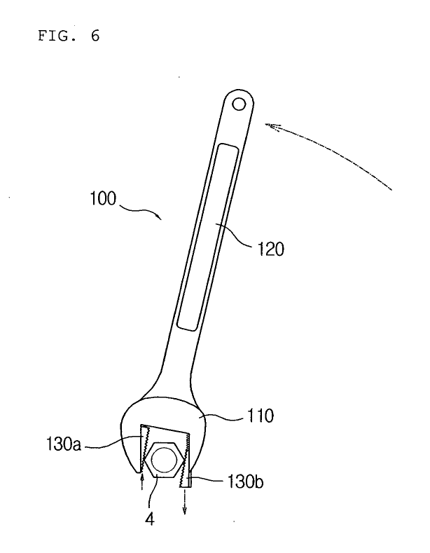

An operation of the spanner having the above-mentioned structure will be now described with reference to FIGS. 4 and 6.

FIG. 4 shows a state of the spanner before fastening the bolt 4, in which the bolt 4 is fitted into the head 110 provided with the first slide piece 130a and the second slide piece 130b.

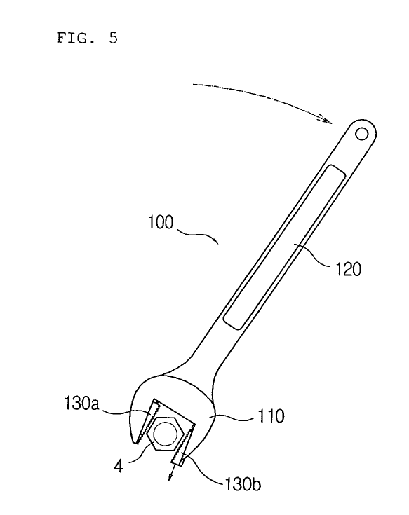

FIG. 5 shows a process of fastening the bolt 4 by clockwise revolving the handle 120 by a fixed angle after fitting the bolt 4 into the head 110.

Referring to the figures, when the handle 120 is revolved by a fixed angle in the clockwise direction, the edge of the bolt 4 comes in line contact with the first and second slide piece 130a and 130b due to a gap between the bolt 4 and the head 110.

At this time, the first slide piece 130a tends to slide in the opening direction of the head 110 by means of reaction to a revolving force of the handle 120. However, since the first slide piece 130a has a wedge shape having an acute angle in the opening direction, the first slide piece 130a is prevented from sliding in the opening direction.

At the same time, since the second slide piece 130b comes in slidable contact with the head 110, it slides in the opening direction by the revolving force of the bolt 4.

FIG. 6 shows a process of rewinding the spanner 100 by revolving the handle 120 in a counterclockwise direction after fastening the bolt shown in FIG. 5.

Referring to the figure, when a user rewinds the spanner 100 by revolving the spanner in the counterclockwise direction with the handle 120, the second slide piece 130b is restored in the direction opposite to the A direction by a restoring force of the coil spring 140 at the moment that the second slide piece 130b is separated from an edge of the bolt 4. Then, when it comes in contact with a next edge of the bolt 4, the second slide piece 130b slides again in the A direction, which is the opening direction, by means of a revolving force of the head 110.

That is, the second slide piece 130b having slid in the opening direction in the course of rewinding the spanner 100 shown in FIG. 6 is restored to the original position in the direction opposite to the opening direction of the head 110 by means of the restoring force of the coil spring 140 and is pushed out again out in the opening direction while engaging with a next edge. In this state, when the user revolves the spanner 100 in the clockwise direction, as shown in FIG. 5, the fastening operation can be again performed.

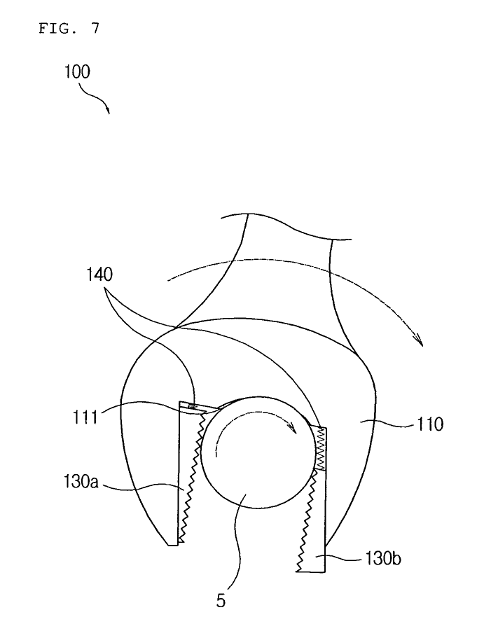

FIG. 7 is a perspective view illustrating a case where the spanner is applied to a circular bolt as an object.

Referring to the figure, a circular arc-shaped screw groove 111 is formed in the inner bottom surface of the head 110 of the spanner 100. A user fits the circumferential portion of the arc-shaped bolt 5 to the screw groove 111, pulls out the second slide piece 130b in the opening direction, allows one end of the second slide piece 130b to come in contact with the circumferential portion of the bolt 5, and fastens the bolt 5 by revolving the spanner 100.

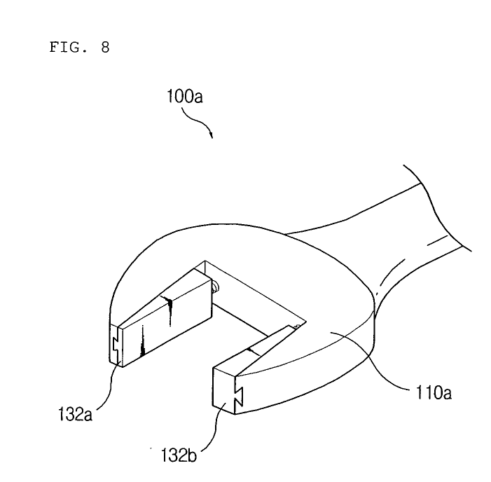

FIG. 8 is a perspective view illustrating a case where the spanner shown in FIG. 3 has no protrusion. A user can use a spanner 100a in which the protrusions on surfaces of the first slide piece 130a and the second slide piece 130b facing the object are removed.

Here, the spanner 100 according to an embodiment of the present invention can effectively fasten a heavily eroded bolt, a hexagonal bolt, an octagonal bolt, and a circular bolt and can be applied to various bolt fastening or loosening tools such as an adjustable wrench or a pipe wrench, in addition to a general spanner.

Since the head 110 of the spanner 100 having the above-mentioned structure and operation includes the first slide piece 130a and the second slide piece 130b, a continuous fastening or loosening operation can be performed by rewinding the head 110 of the spanner 100 without pulling out and fitting again the spanner after once fastening the bolt. Accordingly, it is possible to efficiently perform the operation.

Further, the spanner 100 according to an embodiment of the present invention does not require a space in which the handle can revolve by about 120° but a small space of about 30°, in order to pull out and fit the head again to a bolt or a nut.

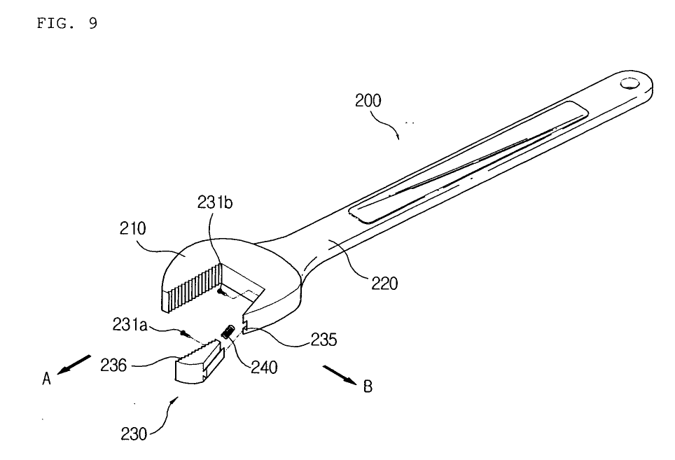

FIG. 9 is a perspective view illustrating a spanner according to another embodiment of the present invention.

Referring to the figure, a spanner 200 according to another embodiment of the present invention includes a handle 220 and a head 210 that is formed at one end of the handle 220 and can be used to fasten and loosen the object.

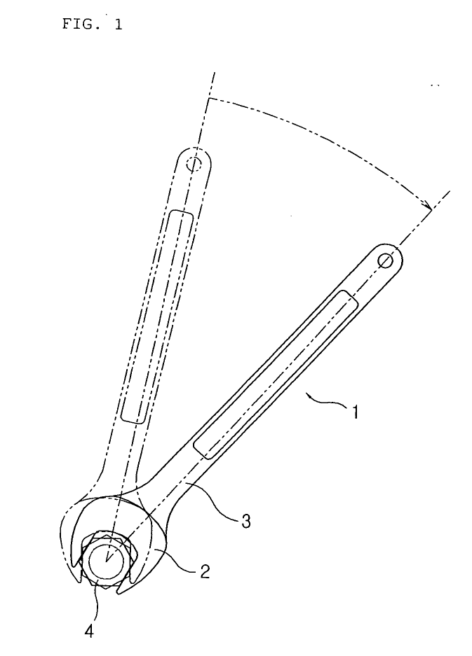

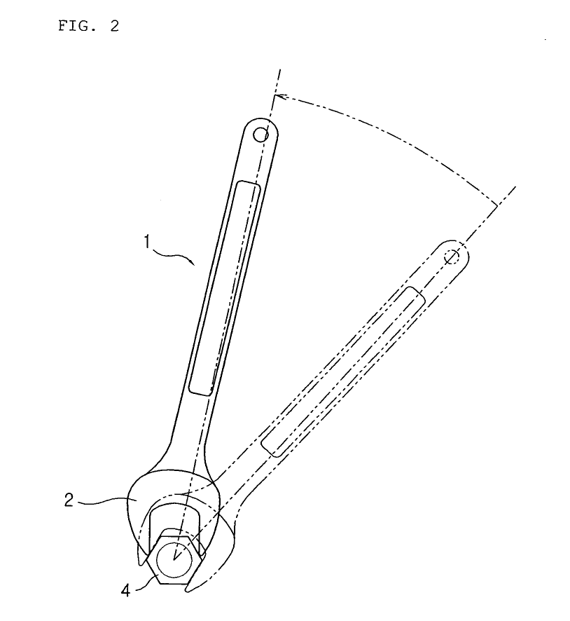

The head 210 is opened in the A direction so as to fit a bolt 4 (see FIG. 1) as the object and has an approximately U shape.

Therefore, a user can fasten or loosen a bolt by revolving the spanner by a predetermined angle in one direction or the opposite direction with the handle 220 extending from the head 210.

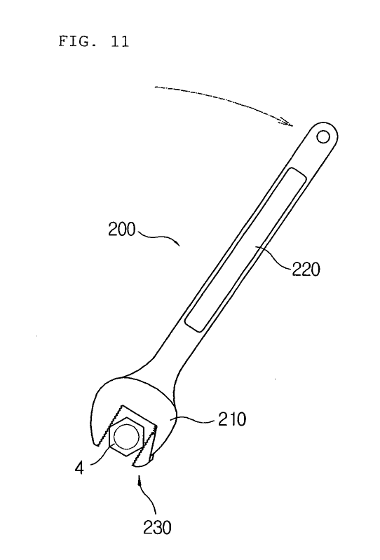

As shown in FIG. 11, a slide piece 230 slidable between the head 210 and the object is provided at the side in the head 210 closer to the user when the user grasps the handle with his right hand, that is, at the side in a B direction (see FIG. 9) closer to the user when the user revolves the spanner 200 to right with respect to the opening direction A.

The slide piece 230 can be slidably coupled to a slide groove 235 of the head 210 to be movable externally from the head 210.

Further, the slide piece 230 may further include a coil spring 240 to elastically bias the slide piece in the direction opposite to the opening direction A of the head 210. The coil spring 240 may be replaced with a leaf spring.

Specifically, the coil spring 240 provided in one end of the slide piece 230 elastically biases the slide piece 230 in the A direction that is the opening direction of the head 210, increases a force for bringing the slide piece into close contact with the object, and gives a restoring force for restoring the slide piece to its original position.

A fixing member 231b fixed to the head 210 can be coupled to one end of the coil spring 240 and a fixing member 231a fixed to the slide piece 230 can be coupled to the other end thereof.

On the other hand, the slide piece 230 has a wedge shape and protrusions 236 are provided so as to effectively fasten or loosen the object by increasing a frictional force on the surface of the slide piece 230 biting the object.

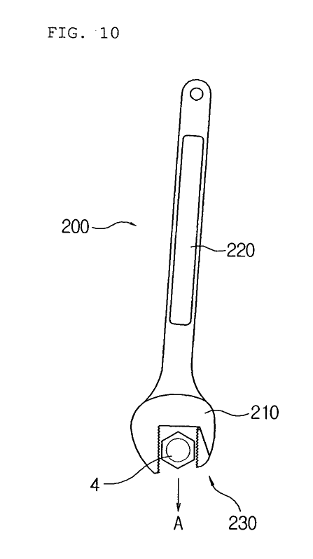

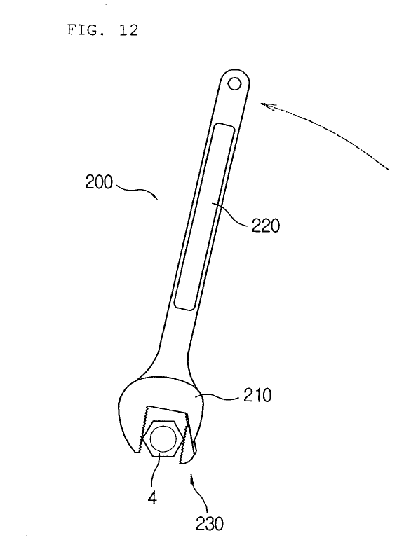

An operation of the spanner having the above-mentioned structure will be described with reference to FIGS. 10 and 12.

Referring to the figures, FIG. 10 shows a state of the spanner before a user fastens the bolt 4 as an object with the handle 220, in which the bolt 4 is inserted into the head 210 of the spanner 200 and the slide piece 230.

FIG. 11 shows a process of fastening the bolt 4 by revolving the handle 220 by a fixed angle in the clockwise direction in the state shown in FIG. 10 where the user inserts the bolt 4 into the head 210.

Referring to the figure, if the user revolves the handle 220 by a fixed angle in the clockwise direction, the edge of the bolt 4 comes in line contact with the slide piece 230 and the head 210 due to the gap between the bolt 4 and the head 210.

At this time, the slide piece 230 tends to slide in the opening direction of the head 210 by means of the reaction to the revolving force of the handle 220, because the slide piece 230 comes in slidable contact with the head 210 and the bolt 4 is revolved.

FIG. 12 shows a process of rewinding the spanner 200 by revolving the handle in the counterclockwise direction after fastening the bolt shown in FIG. 11.

Referring to the figure, when the handle 220 is rewound by revolving the handle by a fixed angle in the counterclockwise direction, the slide piece 230 is restored in the direction opposite to the A direction by means of the restoring force of the coil spring 240 at the moment that it is separated from the edge of the bolt 4. Then, when it comes in contact with the next edge of the bolt 4, the slide piece slides again in the A direction as the opening direction by means of the revolving force of the head 210.

That is, the slide piece 230 having slid in the opening direction in the course of rewinding the spanner 200 shown in FIG. 12 is restored in the direction opposite to the opening direction of the head 210 by means of the restoring force of the coil spring 240 and is then pushed out again in the opening direction while engaging with the next edge. In this state, when the user revolves the spanner 100 in the clockwise direction into the state shown in FIG. 11, the fastening operation can be again performed.

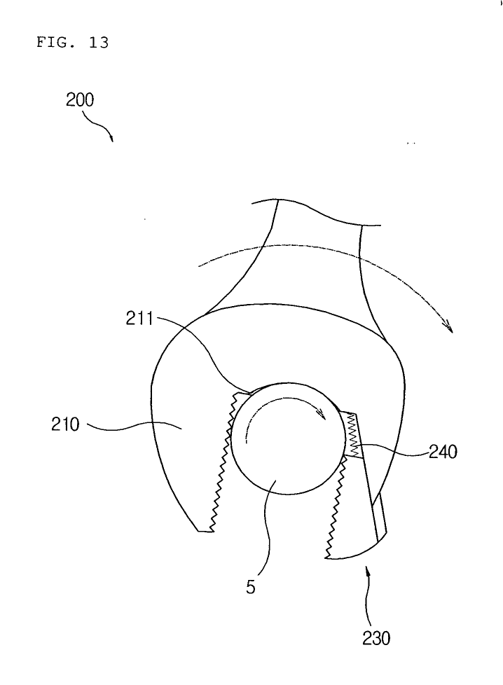

FIG. 13 is a perspective view illustrating a case where the spanner is applied to a circular bolt as an object.

Referring to the figure, a circular arc-shaped screw groove 211 is formed in the inner bottom surface of the head 210 of the spanner 200. A user fits the circumferential surface of the arc-shaped bolt 5 to the arc-shaped screw groove 211, pulls out the slide piece 230 in the opening direction, brings one surface of the slide piece 230 into contact with the circumferential surface of the bolt 5, and fastens the bolt 5 by revolving the spanner 200.

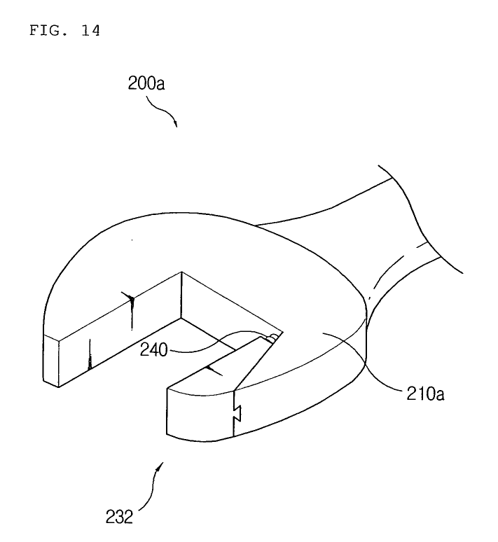

FIG. 14 is a perspective view illustrating a case where the spanner shown in FIG. 9 has no protrusion, in which the protrusions 236 on the surface of the slide piece 230 facing the object are removed from the spanner 200.

Here, by using the spanner 200 according to another embodiment of the present invention, the user can effectively fasten a heavily eroded bolt, a hexagonal bolt, an octagonal bolt, and a circular bolt. The spanner 200 can be applied to tools for fastening or loosening various types of bolts such as an adjustable wrench or a pipe wrench, in addition to general spanner.

Since the spanner 200 having the above-mentioned structure and operation includes the slide piece 230 in the head 210, a continuous fastening or loosening operation can be performed by rewinding the head 210 of the spanner 100 without pulling out and fitting again the spanner after once fastening the bolt. Accordingly, it is possible to efficiently perform the operation.

Further, the spanner 200 according to another embodiment of the present invention does not require a space in which the handle can revolve by about 120° but a small space of about 30°, in order to pull out and fit the head again to a bolt or a nut.

While the present invention has been particularly shown and described with reference to exemplary embodiments thereof, it will be understood by those skilled in the art that various changes in form and details may be made therein without departing from the spirit and scope of the present invention as defined by the appended claims.

### INDUSTRIAL APPLICABILITY

As described above, the spanner according to the present invention can be usefully used as a tool which can fasten or loosen an object such as a bolt and a nut.

1. A spanner comprising:
a head portion fastening and loosening an object:
a pair of slide pieces having a wedge shape and symmetrically positioned inside the head portion, each slide piece being coupled to the head portion to be externally slidable between the head portion and the object; and
a coil spring disposed between an inner bottom surface of the head portion and one end of each slide piece opposed to the inner bottom surface, the coil spring elastically supporting each slide piece so as to elastically bias the slide piece in a direction opposite to an opening direction of the head portion.

2. A spanner comprising:
a head portion fastening and loosening an object:
a slide piece having a wedge shape, the slide piece being coupled to the head portion to be externally slidable between the head portion and the object; and
a coil spring disposed between an inner bottom surface of the head portion and one end of the slide piece opposed to the inner bottom surface, the coil spring elastically supporting the slide piece so as to elastically bias the slide piece in a direction opposite to an opening direction of the head portion.

3. The spanner according to claim 1, wherein fixing members fixed to the inner bottom of the head portion and one end of the corresponding slide piece are coupled to both ends of each coil spring.

4. The spanner according to claim 1, wherein protrusions for giving a frictional force are formed on one surface of the slide piece coming in contact with the object.

5. The spanner according to claim 1, wherein an arc-shaped groove is formed in the inner bottom surface of the head portion.

6. The spanner according to claim 2, wherein fixing members fixed to the inner bottom of the head portion and one end of the corresponding slide piece are coupled to both ends of each coil spring.

7. The spanner according to claim 2, wherein protrusions for giving a frictional force are formed on one surface of the slide piece coming in contact with the object.

8. The spanner according to claim 2, wherein an arc-shaped groove is formed in the inner bottom surface of the head portion.
